(19) United States
(12) Patent Application Publication
(10) Pub. No.: US 2017/0047172 A1
(43) Pub. Date: Feb. 16, 2017

(54) ORGANIC ELECTROLYTE FOR SUPERCAPACITOR, CONTAINING REDOX ACTIVE MATERIAL

(71) Applicant: Korea University Research and Business Foundation, Seoul (KR)

(72) Inventors: Woong Kim, Seoul (KR); Jinwoo Park, Seoul (KR); Byungwoo Kim, Seoul (KR); Young Eun Yoo, Seoul (KR)

(73) Assignee: Korea University Research and Business Foundation, Seoul (KR)

(21) Appl. No.: 15/307,105

(22) PCT Filed: Oct. 5, 2015
(86) PCT No.: PCT/KR2015/010496

§ 371 Date: Oct. 27, 2016

(30) Foreign Application Priority Data
Nov. 4, 2014 (KR) 10-2014-0151898

(51) Int. Cl. H01G 11/60; H01G 11/74; H01G 11/64; H01G 11/68; H01G 11/34; H01G 11/36

(52) U.S. Cl. CPC H01G 11/60; H01G 11/34; H01G 11/36; H01G 11/64; H01G 11/68; H01G 11/74

(57) ABSTRACT

An organic electrolyte for supercapacitors including redox active material is provided for the energy density enhancement.

### CROSS-REFERENCE TO RELATED APPLICATIONS

This application is the U.S. National Phase of International Application No. PCT/KR2015/010496, filed Oct. 5, 2015, which claims priority to Korea Patent Application No. 10-2014-0151898, filed Nov. 11, 2014, the contents of which are incorporated herein by reference in their entirety.

### TECHNICAL FIELD

The present invention relates to an organic electrolyte for supercapacitors including redox active material, which leads to an energy density enhancement. More particularly, the present invention uses an organic electrolyte including redox active material such as decamethylferrocene to increase the cell voltage of supercapacitor and eventually provide an effect of increasing energy density.

### BACKGROUND ART

Supercapacitors are one of the energy storage devices, and increasingly highlighted because of high power density and long lifetime of charging and discharging. The above characteristics are caused by energy storage mechanism based on rapid physical adsorption/desorption of ions in an electric double layer formed on the interface of carbon based electrode and electrolyte. However, the energy density of the above described electric double layer capacitors (EDLCs) are lower than the energy density of batteries by about ten times, and thus, an applicable scope of the EDLCs is greatly limited.

Generally, the methods of increasing the energy density of supercapacitors include using pseudocapacitive materials and applying an asymmetric configuration. The energy density of supercapacitors is proportional to the capacitance and squared value of operation voltage range, and can be increased when the pseudocapacitive materials and the asymmetric configuration are applied, respectively. The pseudocapacitive materials such as transition metal oxides and conductive polymers theoretically have thousands of farad per gram (F/g), but only materials adjacent to their surface are actually used in a charging reaction, and thus, the pseudocapacitive materials have much lower capacitance. Also, the power characteristics of the pseudocapacitor is very low compared with EDLC. Furthermore, since the pseudocapacitive materials mainly use aqueous electrolytes, electrolysis of water restricts operation voltage range within 1.23 V, thermodynamically. When the asymmetrical system using two different electrode materials such carbon based materials and pseudocapacitive materials is applied, the thermodynamic limit of the aqueous electrolyte is overcome and stable operation is possible. However, the surface-limited energy storage of pseudocapacitive materials and slow mobility still restrict their performance. In order to overcome the above problems, various methods such as developing composite materials using a delicate nanostructure, etc., have been used.

Recently, in order to increase the energy density of supercapacitors, an alternative method of using redox materials was suggested. When the material such as potassium iodide, hydroquinone, copper(II) chloride, etc., which can occur redox reaction, is added into the aqueous solution, the capacitance of the carbon electrode based supercapacitor is increased. However, the aqueous electrolyte restricts a cell voltage around 1 V. In order to increase the cell voltage more than 1 V, several researches of supercapacitors using nonaqueous redox electrolytes were performed. However, the addition of redox active molecules into the electrolyte increased an energy density by only two or three times. The development of the above electrolyte is still in a beginning stage, and there is a large potential for improvements especially related to an operation voltage range. Thus, the development of redox-active organic electrolyte and various researches are required to accomplish better understanding and greatly improve performance.

### DETAILED DESCRIPTION OF THE INVENTION

### Technical Problem

Thus, the present inventors have conducted studies to improve the above described problems, and thus, the purpose of the present invention is to provide the method of increasing the energy density of supercapacitors.

In particular, the redox material suitable for THF, which is an organic electrolyte mainly used in the supercapacitor, is selected to increase the voltage and eventually the energy density of supercapacitors.

### Technical Solution

In order to achieve the above-mentioned purpose of the present invention, an organic electrolyte for a supercapacitor comprising redox active material is provided.

The redox active material may increase an operation voltage of supercapacitors.

A redox potential of the redox active material may be within an electrochemical stable voltage range of the electrolyte.

The redox potential of the redox active material may be less than 0.3 V with respect to an Ag/Ag⁺ electrode.

The supercapacitor may include an electrode such as CNT or activated carbon.

The redox active material may include DmFc, anthracene, or derivatives thereof.

The electrolyte may include a solution including tetrabutylammonium perchlorate (TBAP) added in tetrahydrofuran (THF), acetonitrile, or propylene carbonate.

The redox potential may be positioned adjacent to one of two ends of a stable voltage range of a supporting electrolyte.

The redox reaction of the DmFc may be performed on a positive electrode of the supercapacitor.

An operation voltage of the supercapacitor including the organic electrolyte having the DmFc may be about 2.1 V.

The DmFc may be added at a ratio of about 0.1 to 0.7 with respect to a mole concentration of the TBAP, and preferably added at a ratio of about 0.2.

### Advantageous Effects

According to the present invention, redox pairs are added in an electrolyte, and thus, the energy density enhancement of supercapacitors is provided by about 30 times. The above result shows improvements of capacitance and operation voltage, which are attributed from an additional pseudocapacitance and an asymmetric behavior of each electrode, respectively. Thus, the operation voltage of the supercapacitor is determined by an electrochemically stable range of an organic electrolyte and relative position of a redox potential. The present invention may be applied to various organic electrolyte, and the capacitance maintains 88.4% after about 10,000 times of charging and discharging.

### BRIEF DESCRIPTION OF THE DRAWINGS

FIGS. 1(a), 1(b), 1(c) and 1(d)-FIG. 1(a) is a view schematically illustrating a supercapacitor cell. FIG. 1(b) and FIG. 1(c) are SEM images of single-walled carbon nanotubes (SWNTs) and carbon paper (CP). FIG. 1(d) is illustrating molecular structures of decamethylferrocene (DmFc), tetrabutyl ammonium perchlorate (TBAP), and tetrahydrofuran (THF).

FIGS. 2(a) and 2(b) are graph illustrating galvanostatic charge/discharge curves and operation potentials of positive and negative electrodes in FIG. 2(a) TBAP/THF and FIG. 2(b) DmFc/TBAP/THF measured at a current density of 2.5 A/g.

FIGS. 3(a), 3(b), 3(c) and 3(d)-FIG. 3(a) is a graph of cyclic voltammetry (CV) curves at 100 mV/s when DmFc is in a TBAP/THF electrolyte and without DmFc, and FIG. 3(b) is a graph of the capacitance per mass (C_{cell}) vs. current density, and FIG. 3(c) is a Ragone plot corresponding thereto, and FIG. 3(d) is a graph illustrating stable during charging and discharging of the supercapacitor including electrolyte of DmFc/TBAP/THF measured at 5 A/g.

FIGS. 4(a), 4(b), 4(c), 4(d) and 4(c) are graph illustrating positions of redox potential with reference to a stable voltage range. In non-ideal cases, FIG. 4(a) redox potential is placed outside of an electrochemical stable voltage range of a supporting electrolyte (a solid arrow), and FIG. 4(b) the redox potential is positioned adjacent to the center of voltage range, and FIG. 4(c) side reaction of redox molecules is in the voltage range. In ideal cases, the redox potential is located adjacent at an upper side (FIG. 4(d)) or a lower side (FIG. 4(e)). A red line represents a potential of redox molecules. A blue line is a potential at which the side reaction of redox mediator occurs. The dotted arrow represents the range of operation voltage range.

FIG. 5 is a cyclic voltammetry curve illustrating that the electrolyte is electrically stable in the range of 2.7 V. The THF or TBAP reacts when the voltage is out of the stable range, which increases current.

### BEST MODE OF THE INVENTION

Hereinafter, the present invention will be explained in detail.

In the present invention, in order to increase the energy density of supercapacitors, a redox active material is added into an organic electrolyte, and thus, electrochemical characteristics of dramatic voltage increase is identified.

In detail, the present invention is related to the carbon nanotube based supercapacitors with the incorporation of redox material, decamethylferrocene (Hereinafter, referred to as DmFc), into an organic electrolyte. Since particular redox active material is added into the organic electrolyte, the effect of an energy density enhancement in supercapacitors may be provided.

When the redox active material is added, the pairs thereof are formed by an electrochemical reaction. Actually, the redox active material is added into the organic electrolyte, and a part of material reacts to form the pairs thereof, thereby working.

The redox material may include a redox active material having a redox potential of less than or equal to 0.3 V with respect to an Ag/Ag⁺ electrode.

In DmFc of the embodiments, the redox potential is −0.32 V (vs. Ag/Ag⁺), and therefore, a cell voltage is 2.1 V. Ultimately, a cell voltage of more than or equal to 2.7 V may be manufactured using the electrolyte of the present invention. The above may be highly competitive in this research field, and the above-described performance may be realized using a material (for example, anthracene and derivative thereof) having a redox potential of 0.6 V higher than DmFc (−0.32V vs. Ag/Ag⁺).

In one embodiment of the present invention, the supercapacitor may have a structure including an electrode material and an electrolyte. Here, the electrode material may include CNT or activated carbon, and the electrolyte may include a solution of tetrahydrofuran (THF) with adding tetrabutylammonium perchlorate (TBAP). The CNT has excellent characteristics as the electrode material, and it may supplement or replace the conventionally used activated carbon in a particular application field of the supercapacitor in the future.

The present invention is characterized in the electrolyte where DmFc is added. DmFc forms stable redox pairs with decamethylferrocenium (DmFc⁺), and is easily dissolved in TBAP/THF which is a supporting electrolyte. The TBAP/THF which is the organic electrolyte according to the present invention is preferable to understanding a voltage range affected by DmFc. The energy density improvement of the supercapacitor including DmFc is ascribed from the increased capacitance by a faradaic redox reaction from DmFc and the widen cell voltage through the change in an operation voltage range of each electrode by adding DmFc. Also, the supercapacitor including DmFc has competent performance characteristics of charging and discharging stability and rate capability. Thus, in the present invention, the factor of restricting the cell voltage in supercapacitors is found, and the present invention is completed to develop new electrolyte of improving energy density.

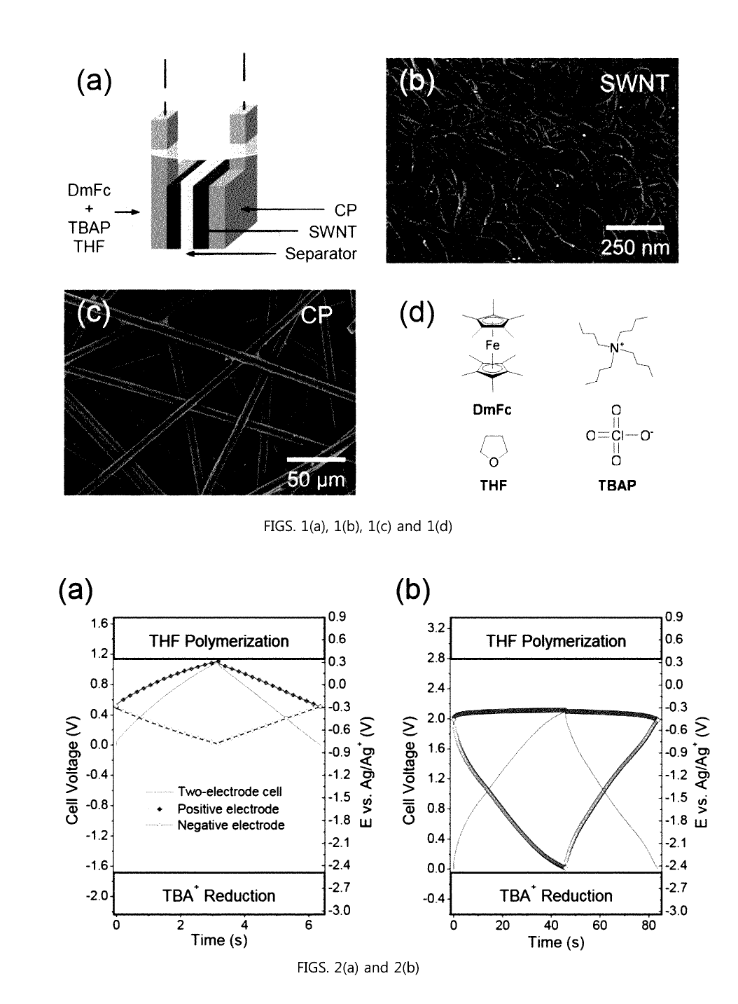

In one embodiment of the present invention, single walled CNTs (SWNTs), DmFc/TBAP/THF, and carbon paper (CP) were used as electrode material, electrolyte, and current collector of the supercapacitor, respectively (shown in FIG. 1a). SWNTs bundles twisted by a diameter of 0.7 to 1.4 nm on a piece of CP may be clearly observed by a scanning electron microscope (SEM) (shown in FIG. 1b). The CP is a plate of clotted carbon fiber (a diameter of around 7 μm) having a thickness of almost 280 μm and an inner surface resistance of around 5.6 mΩ·cm. The CP is widely used as a current collector in researches related to fuel cells and supercapacitors. The DmFc was used as a material for redox reaction, and added into the supporting electrolyte including TBAP and THF (shown in FIG. 1d). Since Fe(II) of DmFc is easily oxidized into Fe(III) of DmFc⁺ and reduced into Fe(II), DmFc forms redox pairs with DmFc.

As shown in FIG. 2, the cell voltage of supercapacitor without DmFc is limited into 1.1 V (shown in FIG. 2a). When the redox pair does not exist, the cell voltage is almost equally divided into two electrodes during the galvanostatic charging-discharging experiments (GCD). The potential of a positive electrode is changed from about −0.29 V to 0.32 V (vs. Ag/Ag⁺), and that of a negative electrode is changed from −0.29 V to −0.79 V (vs. Ag/Ag⁺). The cell voltage is mainly limited by the positive electrode. The potential of the positive electrode should not exceed 0.33 V (vs. Ag/Ag⁺) at which electric polymerization of THF solvent occurs, and the above limited condition is illustrated as colored area in FIG. 2.

In the cell including DmFc, the operation voltage is expanded into 2.1 V (shown in FIG. 2b). The effect of redox mediator is shown by comparing the electrochemical characteristics of the supercapacitor with or without DmFc (in FIG. 2). When DmFc is included, the cell voltage is asymmetrically divided into two electrodes, and the operation voltages of electrodes are changed accordingly. The above asymmetry is generated by different charge storage mechanism of the electrodes. Faradaic process is generated at the positive electrode, and non-Faradaic process is generated at the negative electrode, and as a result, the each electrode shows a battery type and an EDLC type, respectively. The potential of the positive electrode is slightly changed from −0.46V to −0.33 V (vs. Ag/Ag⁺), and the above is close to a redox potential (−0.32 V) of DmFc. The above value is obtained from measuring cyclic voltammetry (CV) experiment using three electrode configuration. The above result represents that DmFc/DmFc⁺ redox reaction occurs at the positive electrode. The capacitance generated from the pseudocapacitor is based on the redox reaction, and thus, the positive electrode shows high capacitance as 1,626 F/g at 2.5 A/g. The potential of the positive electrode having the relatively constant value, on the contrary, the potential of the negative electrode is greatly changed from −0.46 V into −2.43 V vs. Ag/Ag⁺, and shows capacitance per mass of the electrode as 98 F/g.

The operation voltage of the supercapacitor including DmFc is determined by redox potential of DmFc and reduction potential of TBA⁺. Since the redox potential (−0.32 V) of DmFc is lower than the potential (0.33 V) of electric polymerization of THF, the redox potential (−0.32 V) of DmFc becomes upper limit of the cell voltage. Meanwhile, the potential of the negative electrode should not be lower than about −2.4 V vs. Ag/Ag⁺ at which TBA⁺ positive ions of the electrolyte are reduced. As a result, the operation voltage range of the supercapacitor including DmFc is 2.1 V, which is about twice higher than without DmFc.

By adding DmFc, the capacitance per mass as well as the cell voltage is greatly increased (from 7.5 F/g into 46.3 F/g at 2.5 A/g). The increased capacitance when DmFc is added may be deduced by a gentle slope (ΔV/Δt) of a discharging curve (shown in FIG. 2), which is attributed to the pseudocapacitance of DmFc faradaic reaction. The energy density is greatly enhanced by the increase of voltage range and capacitance (from 1.2 Wh/kg into 27.0 Wh/kg at 2.5 A/g). Also, the increase of capacitance is continuously exhibited in CV curves (from 7.7 F/g to 38.3 F/g). Detailed information on cell capacitance, capacitance of each electrode, energy density, power density, operation voltage range, etc., were provided in Table 1.

TABLE 1

| | Positive | | | Negative | | | Cell | | Power | Energy |
|---|---|---|---|---|---|---|---|---|---|---|
| | Electrode | | | Electrode | | | Capacitance | | Density | Density |
| | m₊ | ΔV₊ | C_{elec+} | m₋ | ΔV₋ | C_{elec-} | C | C_{cell} | P_{cell} | E_{cell} |
| | (mg) | (V) | (mF) | (mg) | (V) | (mF) | (mF) | (F/g) | (kW/kg) | (Wh/kg) |
| TBAP/THF | 0.4 | 0.576 | 11.0 | 0.4 | 0.479 | 13.2 | 6.0 | 7.5 | 1.32 | 1.16 |
| DmFc/ | 0.4 | 0.117 | 651 | 0.4 | 1.931 | 39.3 | 37.1 | 46.3 | 2.56 | 27.0 |
| TBAP/THF | | | | | | | | | | |

Mass, operation voltage range, capacitance of each electrode, cell capacitance per mass, energy density and power density of the supercapacitor with or without DmFc in TBAP/THF electrolyte when I=2.5 A/g.

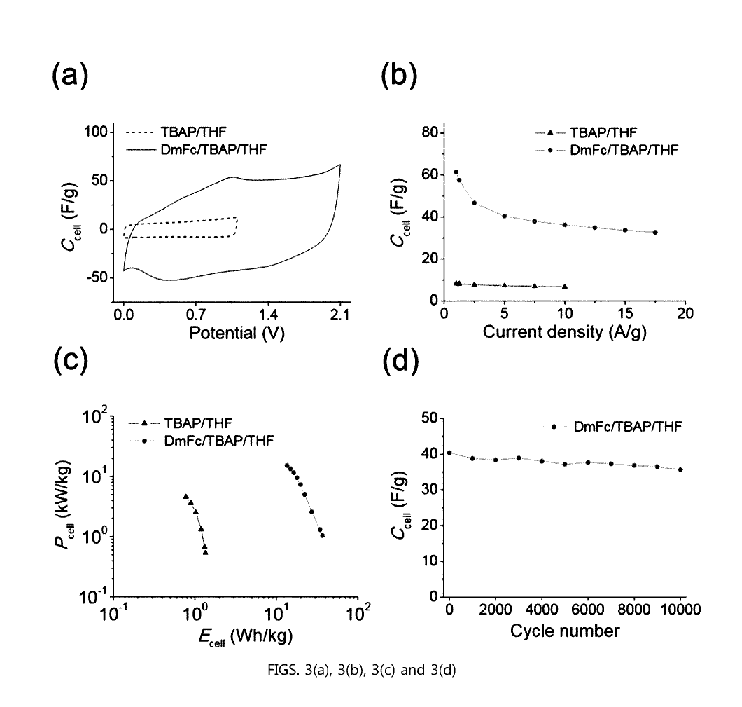

The supercapacitor including DmFc shows good rate capability. Although the pseudo capacitor has high energy density, it follows chemical mechanism different from physical energy storage mechanism of EDLC, and thus, the pseudocapacitor is slower than EDLC. Thus, the performance characteristics according to the discharge speed is an important factor considered in determining characteristics of the pseudocapacitor. FIG. 3b shows the decrease of C_{cell} as the current density increases. Normally, when DmFc is included, the capacitance per mass is more rapidly decreased than the case without DmFc. The above is proper in consideration with chemical redox reaction of DmFc. When the current density is relatively low, C_{cell} is rapidly decreased. As the current density increases, the decrease amount of C_{cell} is lower.

At a current density of 1 A/g, C_{cell} of the supercapacitor including DmFc is greater than that of the supercapacitor without DmFc by about 7 times (61.3 vs. 8.3 F/g), and at the current density of 10 A/g, C_{cell} of the supercapacitor including DmFc is greater than that without DmFc by about 5 times (36.2 vs. 6.8 F/g). The above result means that the redox reaction of DmFc on CNT electrode is rapid and reversible, and it is the reason why the supercapacitor including DmFc shows good power performance.

As shown in FIG. 3, Ragone graph illustrates that energy performance is greatly improved while adding DmFc does not cause severe problem in power performance (shown in FIG. 3c). Energy density and power density are estimated from GCD graphs measured at various current densities. When redox pairs are added, capacitance is increased from 8.3 F/g to 61.3 F/g at 1 A/g, and operation voltage range is greatly increased from 1.1 V to 2.1 V, and thus, energy density and power density are increased accordingly. After DmFc is added, energy density was increased by about 27 times (from 1.35 Wh/kg to 36.76 Wh/kg at 1 A/g), and power density was increased by about twice (from 0.54 kW/kg to 1.04 kW/kg at 1 A/g). Also, the supercapacitor including DmFc shows excellent stability during charging and discharging. The retention of C_{cell} at 5 A/g was 88.4% after 10,000 times of charging-discharging cycles (FIG. 3d). This indicates that DmFc/DmFc⁺ redox pairs are very stable during repeating charging and discharging at wide operation voltage range.

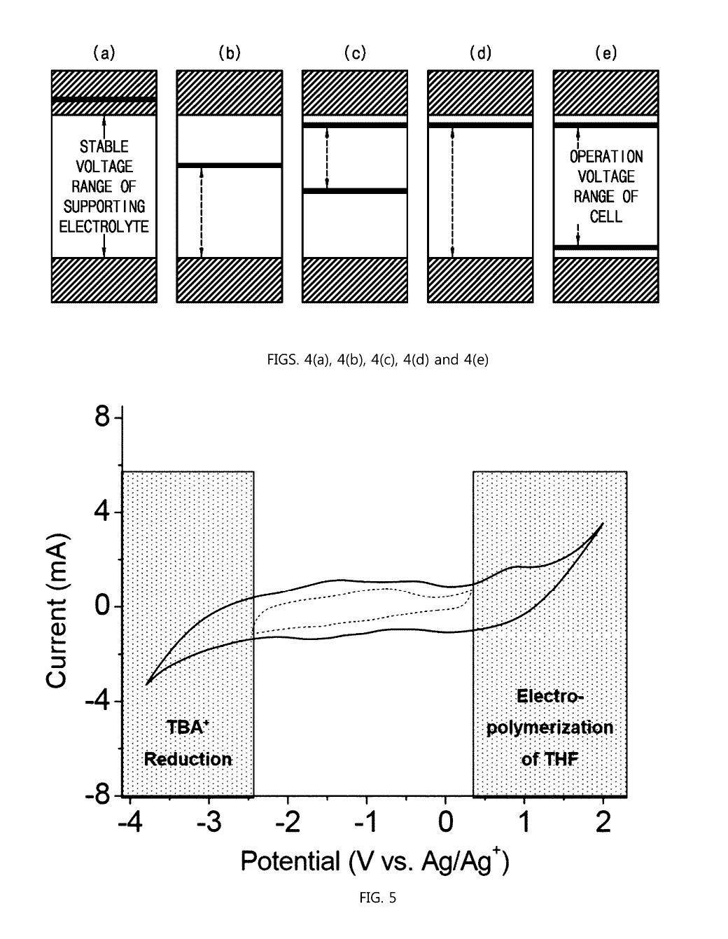

According to the present invention, it was discovered that the cell voltage is restricted by electrochemical stability of supporting electrolyte ions and solvent (TBA⁺ reduction and THF polymerization) and redox potential of redox active material (DmFc). The above discovery may be a useful guideline to determine the component of new electrolytes which are capable of more greatly improving energy density of supercapacitors. Firstly, the redox potential should be positioned within electrochemically stable voltage range of supporting electrolyte. If the redox potential exists out of the above range, the cell voltage is restricted by ions or solvent degradation, not by the redox reaction. Then, increase of additional capacitance caused by redox reaction disappears (FIG. 4a). In case of TBAP/THF electrolyte of the embodiment, the stable voltage range (2.7 V) of the supporting electrolyte is determined by THF electropolymerization and TBA⁺ reduction potential (from 0.3 V to −2.4 V vs. Ag/Ag⁺). Here, the actual operation range of the supercapacitor is lower than the stable range of supporting electrolyte, and the operation voltage of the supercapacitor with DmFc is 2.1 V. Secondly, the redox potential should exist adjacent to one end of the stable voltage range of supporting electrolyte. When the redox potential is positioned adjacent to the center of voltage range, the stable voltage window may not be sufficiently used, and as shown in FIG. 4b, the operation cell voltage range is narrowed by the redox potential. Also, the operation voltage range (2.1 V) is determined by the redox potential of DmFc and the reduction potential of TBA⁺ (from −0.3 V to −2.4 V vs. Ag/Ag⁺). Thus, when the redox molecules with a potential between 0.3 V and −0.3 V (vs. Ag/Ag⁺) are used, the operation voltage range may be increased more to about 0.6 V. Thirdly, the redox molecules should not join undesired side reaction within the stable voltage range of supporting electrolyte. When the side reaction is generated, as shown in FIG. 4c, the potential of the side reaction may determine the cell voltage. Finally, the redox reaction should be rapid and reversible, and the redox mediator and the supporting electrolyte should have enough high solubility and wide electrochemical stable voltage range, respectively. Considering the above conditions, the ideal situations are illustrated in FIGS. 4d and 4e. In this case, the operation voltage range is maximized, and the capacitance caused by the pseudocapacitor may be applicable.

In short, when the supercapacitor including the organic electrolyte incorporating DmFc redox active material in the TBAP/THF electrolyte is compared with the supercapacitor without DmFc, it was verified that the energy density is greatly increased (from 1.3 Wh/kg to 36.8 Wh/kg at 1 A/g). The DmFc redox pairs increase the capacitance per mass (from 8.3 F/g to 61.3 F/g at 1 A/g) and the voltage range (from 1.1 V to 2.1 V) by controlling the pseudocapacitive reaction and the operation voltage of both electrodes. Also, the supercapacitor including DmFc shows good rate capability and cyclability (88.4% C_{cell} retention at 5 A/g after 10,000 times of charging and discharging). It was shown that the electrochemical stable voltage range of TBAP/THF and the redox potential of DmFc determine the cell voltage. Based on the above result, a general strategy of developing a new electrolyte capable of improving the energy density of supercapacitors is proposed.

### Mode of the Invention

Hereinafter, the embodiments are only used to explain the present invention in detail, it is obvious that the scope of the present invention based on the inventive concept is not limited by the embodiments by one of ordinary skill in the art.

### Embodiment 1

### Preparation of Electrolyte and Electrode

DmFc (99%, Alfa Aesar) and TBAP (≧99.0%, Sigma-Aldrich) were dissolved in THF (≧99.9%, Sigma-Aldrich), and agitated for about 30 minutes. In order to prepare an electrode, SWNTs (20 mg, a diameter of 0.7 to 1.4 nm, Sigma-Aldrich) were added into propylene carbonate (PC, 20 mL, Sigma-Aldrich), and the solution was bar-sonicated (Sonics & materials, VC 750) for one hour. Then, the CNT solution was dropped on the current collector, CP (1 cm×1 cm, Toray Industries Inc., TGP-H-090) on a hot plate (250° C.). Surface morphologies of CNTs and CP were observed through a field emission SEM (Hitachi, S-4800). Specific surface area of SWNTs was about 1,125 m²/g.

### Embodiment 2

### Fabrication and Characterization of Cell

The cell fabrication was carried out in a glove box. A polytetrafluoroethylene membrane (a thickness of ˜65 μm, a pore size of ˜0.2 μm, Millipore) was inserted between two same SWNT electrodes, and was wrapped with Teflon sealing tape. Then, the fabricated electrode was dipped into an electrolyte solution (4.6 mL; 0.2 M DmFc and 1 M TBAP in THF) in a glass container (a height of ˜11.5 cm, an outer diameter of ˜3.3 cm, and an inner diameter of ˜2.5 cm). The completed cell was sealed and taken out from the glove box. Without any additional comment, electrochemical characterization was performed through two-electrode configuration using an analysis device (BioLogic, VSP-300). In order to identify how to change the voltage of each electrode during the charging-discharging process of the cell, Ag/Ag⁺ (including 0.1 M TBAP and 0.01 M AgNO₃ in acetonitrile solution, 0.543 V vs. standard hydrogen electrode) and platinum gauze (52 mesh, 99.9%, Sigma-Aldrich) were used as reference and counter electrodes, respectively.

1. An organic electrolyte for supercapacitors comprising redox active material.

2. The organic electrolyte of claim 1, wherein the redox active material increases a voltage of supercapacitor.

3. The organic electrolyte of claim 1, wherein a redox potential of redox active material is within the electrochemical stable voltage range of electrolyte.

4. The organic electrolyte of claim 1, wherein the supercapacitor comprises an electrode including CNT or activated carbon.

5. The organic electrolyte of claim 1, wherein the redox active material comprises DmFc, anthracene, or derivatives thereof.

6. The organic electrolyte of claim 5, wherein the DmFc reacts into DmFc⁺ through redox reaction

7. The organic electrolyte of claim 1, wherein the organic electrolyte comprises a solution including tetrabutylammonium perchlorate (TBAP) added in tetrahydrofuran (THF) or acetonitrile, or propylene carbonate.

8. The organic electrolyte of claim 3, wherein the redox potential is positioned adjacent to one of two ends of a stable voltage range of a supporting electrolyte.

9. The organic electrolyte of claim 6, wherein the redox reaction of the DmFc is performed on the positive electrode of the supercapacitor.

10. The organic electrolyte of claim 5, wherein an operation voltage of the supercapacitor including the organic electrolyte having the DmFc is about 2.1 V.
